(19) United States
(12) Patent Application Publication
(10) Pub. No.: US 2021/0311285 A1
(43) Pub. Date: Oct. 7, 2021

(54) LENS DEVICE, IMAGING DEVICE, AND MOBILE OBJECT

(71) Applicant: VICTOR HASSELBLAD AB, GÖTENBORG (SE)

(72) Inventors: Masahiro SHIRONO, Tokyo (JP); Longji BAI, Tokyo (JP)

(21) Appl. No.: 17/351,208

(22) Filed: Jun. 17, 2021

Related U.S. Application Data
(63) Continuation of application No. PCT/CN2019/123721, filed on Dec. 6, 2019.

(30) Foreign Application Priority Data
Dec. 20, 2018 (JP) 2018-237823

(51) Int. Cl. G02B 9/04; G02B 7/02

(52) U.S. Cl. CPC G02B 9/04; G02B 7/021

(57) ABSTRACT

A lens device includes a first lens group including at least a lens, a second lens group including at least another lens, a light amount control mechanism arranged between the first lens group and the second lens group, and used to control a light amount through the second lens group, and a holding frame used to detachably hold the light amount control mechanism in a state that a positional relationship between the first lens group and the second lens group is maintained.

### CROSS-REFERENCE TO RELATED APPLICATIONS

This application is a continuation of International Application No. PCT/CN2019/123721, filed Dec. 6, 2019, which claims priority to Japanese Patent Application No. 2018-237823, filed Dec. 20, 2018, the entire contents of both of which are incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to a lens device, an imaging device, and a mobile object.

### BACKGROUND

Patent document 1 discloses an imaging device including aperture blades that can be disassembled and assembled in a lens system, and a light volume adjustment filter with a neutral filter. Patent document 1: Japanese Patent Application Publication No. 2003-46819.

### SUMMARY

In accordance with the disclosure, there is provided a lens device including a first lens group including at least a lens, a second lens group including at least another lens, a light amount control mechanism arranged between the first lens group and the second lens group, and used to control a light amount through the second lens group, and a holding frame used to detachably hold the light amount control mechanism in a state that a positional relationship between the first lens group and the second lens group is maintained.

Also in accordance with the disclosure, there is provided an imaging device including an image sensor and a lens device. The lens device includes a first lens group including at least a lens, a second lens group including at least another lens, a light amount control mechanism arranged between the first lens group and the second lens group, and used to control a light amount through the second lens group, and a holding frame used to detachably hold the light amount control mechanism in a state that a positional relationship between the first lens group and the second lens group is maintained.

Also in accordance with the disclosure, there is provided a mobile object configured to move, including an imaging device including an image sensor and a lens device. The lens device includes a first lens group including at least a lens, a second lens group including at least another lens, a light amount control mechanism arranged between the first lens group and the second lens group, and used to control a light amount through the second lens group, and a holding frame used to detachably hold the light amount control mechanism in a state that a positional relationship between the first lens group and the second lens group is maintained.

### BRIEF DESCRIPTION OF THE DRAWINGS

FIG. 1 is a perspective view of an example imaging device.

FIG. 2 is a schematic functional block diagram of an example imaging device.

FIG. 3 shows a cross-sectional view in an optical axis direction of a part of a lens system of a lens unit.

FIG. 4 is a schematic diagram showing an example of a process for removing a second lens frame and a light amount control mechanism.

FIG. 5 is a schematic diagram showing an image-side view of a mobile frame, the light amount control mechanism, and the second lens frame.

FIG. 6 is an example of a cross-sectional view in the optical axis direction of a first lens frame, the mobile frame, the light amount control mechanism, and the second lens frame.

FIG. 7 is a diagram showing an example of a state in which a light amount mobile mechanism is detached from the mobile frame.

FIG. 8 is a diagram showing an example of a state in which a light amount mobile mechanism is detached from the mobile frame.

FIG. 9 is a diagram showing an example appearance of an unmanned aerial vehicle and a remote control.

Reference numerals: UAV 10; UAV main body 20; Light amount control mechanism 35, 350; Mobile frame 40, 400; First lens frame 41, 410; Second lens frame 42, 420; Lens hood 43; Cam pin 44, 402; Gimbal 50; Imaging device 60; Imaging device 100; Imaging unit 102; Imaging controller 110; Image sensor 120; Memory 130; Display 160; Instruction device 162; Lens unit 200; Lens 210; Lens moving mechanism 212; Lens controller 220; Memory 222; Remote control 300; Motor 351, 352; Connection terminal 353, 424; Recess 401; Opening 403; First surface 405; Second surface 406; First lens group 415; Second lens group 425; Fixation member 422.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The embodiments of the present disclosure will be described with reference to the flow charts and block diagrams. As used herein, the blocks may represent operation processes or components of the device that perform operations. The specific processes and components may be implemented by programmable circuits and/or processors. The circuits may include digital and/or analog hardware circuits, may include integrated circuits (ICs) and/or discrete circuits. The programmable circuits may include reconfigurable hardware circuits. The reconfigurable hardware circuits may include logical operations, such as the logical operation AND, the logical operation OR, the logical operation XOR, the logical operation NAND, and the logical operation NOR, etc. The reconfigurable hardware circuits may also include storage elements, such as flip-flops, registers, field programmable gate arrays (FPGAs), and programmable logic arrays (PLAs), etc.

The operations specified in the flow chart or block diagram may be implemented in the form of program instructions stored on a computer-readable storage medium, which may be sold or used as a standalone product. The computer-readable storage medium may be any suitable device that may store program instructions, which may include an electronic storage medium, a magnetic storage medium, an optic storage medium, an electromagnetic storage medium, and a semiconductor storage medium, etc. The computer-readable storage medium may be, for example, a floppy® disk, a soft disk, a hard disk, a random-access memory (RAM), a read-only memory (ROM), an erasable programmable read-only memory (EPROM or flash memory), an electrically erasable programmable read-only memory (EEPROM), a static random-access memory (SRAM), a compact disc read-only memory (CD-ROM), a digital versatile disc (DVD), a Bluray® disc, a memory stick, or an integrated circuit chip, etc.

The computer-readable instructions may include any one of source code or object code described in any combination of one or more programming languages. The source code or the object code includes traditional procedural programming languages. The traditional programming language may be assembly instructions, instruction set architecture (ISA) instructions, machine instructions, machine-related instructions, microcode, firmware instructions, status setting data, an object programming language, e.g., Smalltalk, JAVA (registered trademark), or C++, etc., or “C” programming language. The computer-readable instructions may be provided locally or provided to a processor or a programmable circuit of a general-purpose computer, a special-purpose computer, or another programmable data processing device via a wide area network (WAN), e.g., a local area network (LAN), or the Internet. The processor or the programmable circuit may execute computer-readable instructions to perform the operations specified in the flow chart or block diagram. The processor may be a computer processor, a processing unit, a microprocessor, a digital signal processor, a controller, or a microcontroller, etc.

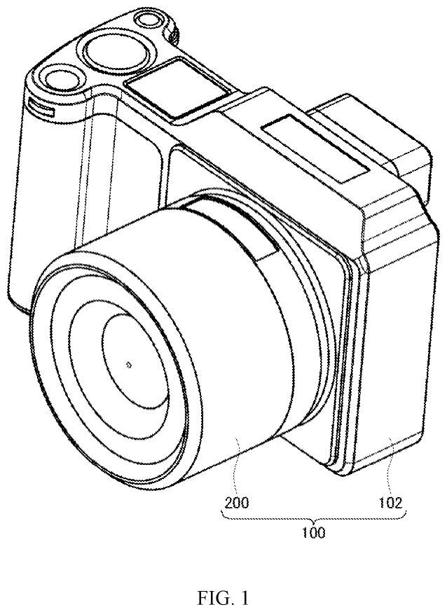

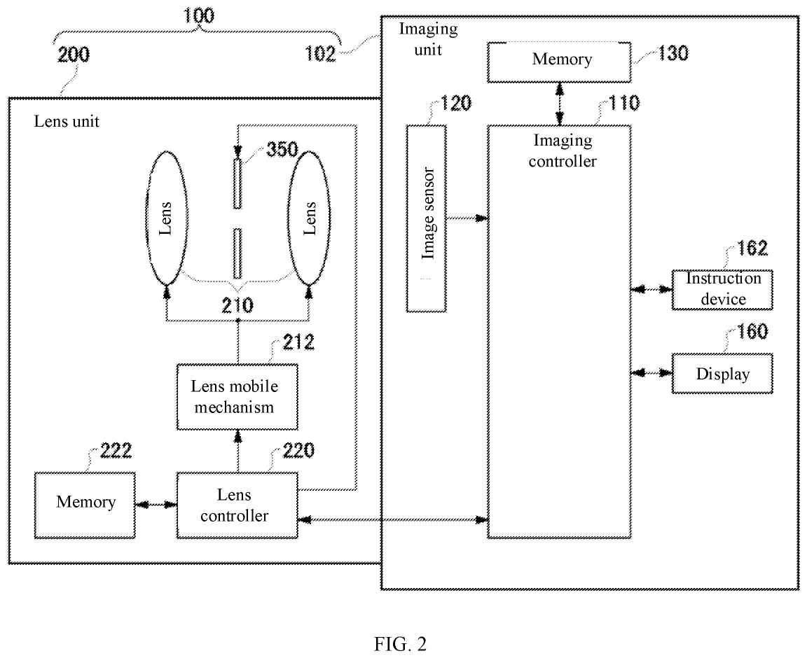

FIG. 1 is a perspective view of an imaging device 100 consistent with embodiments of the disclosure. FIG. 2 is a schematic functional block diagram of the imaging device 100.

The imaging device 100 includes an imaging unit 102 and a lens unit 200. The imaging unit 102 includes an image sensor 120, an imaging controller 110, and a memory 130. The image sensor 120 may include a charge coupled device (CCD) or a complementary metal oxide semiconductor (CMOS). The image sensor 120 outputs image data of the optic image formed by the lens 210 to the imaging controller 110. The imaging controller 110 may include the microprocessor, e.g., a central processing unit (CPU) or a microprocessor unit (MPU), or a microcontroller, e.g., a microprogrammed control unit (MCU), etc. The memory 130 may be the computer-readable storage medium and may include at least one of an SRAM, a dynamic random-access memory (DRAM), an EPROM, an EEPROM, or a flash memory such as a USB memory. The memory 130 stores a program for the imaging controller 110 to control the image sensor 120, etc. The memory 130 may be provided inside a casing of the imaging device 100. The memory 130 may be detachably mounted at the casing of the imaging device 100.

The imaging unit 102 further includes an instruction device 162 and a display 160. The instruction device 162 is a user interface receiving an instruction to the imaging device 100 from a user. The display 160 displays an image captured by the image sensor 120, various setting information of the imaging device 100, etc. The display 160 may include a touch panel.

The lens unit 200 includes a plurality of lenses 210, a light amount control mechanism 350, a lens moving mechanism 212, and a lens controller 220. The plurality of lenses 210 may be used as a single focal length lens. The plurality of lenses 210 are movably arranged along an optical axis. The lens unit 200 may be an interchangeable lens detachably mounted to the imaging unit 102. The lens moving mechanism 212 enables the plurality of lenses 210 to move along the optical axis. The lens controller 220 drives the lens moving mechanism 212 to enable one or more lenses 210 to move along the optical axis according to a lens control instruction from the imaging unit 102. The lens moving mechanism 212 may include a motor, a cam ring driven by the motor, and a mobile frame that moves along with the lens in the optical axis direction as the cam ring rotates. The motor may include a step motor, a DC motor, a coreless motor, or an ultrasonic motor.

The lens unit 200 also includes the memory 222. The memory 222 stores control values for the plurality of lenses 210 to be moved via the lens moving mechanism 212. The memory 222 may include the at least one of an SRAM, a DRAM, an EPROM, an EEPROM, or a flash memory such as a USB memory.

The light amount control mechanism 350 controls a light amount of light incident on the image sensor 120. The light amount control mechanism 350 includes at least one of an aperture mechanism or a shutter mechanism. The light amount control mechanism 350 may include a plurality of aperture blades. The light amount control mechanism 350 may include an actuator. The actuator may include an electromagnetic actuator. The electromagnetic actuator may include an electromagnet, a solenoid, or a step motor. The light amount control mechanism 350 may receive an instruction from the lens controller 220, drive the actuator, adjust an overlapping degree of the plurality of aperture blades, and adjust a size of an aperture.

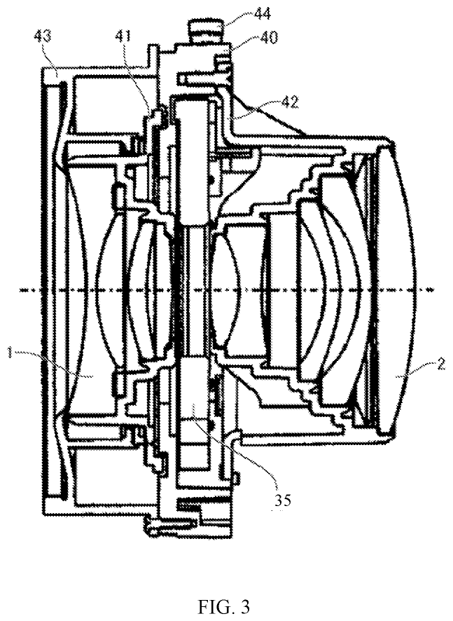

For the imaging device 100 described above, the light amount control mechanism 350 may be removed. FIG. 3 shows a cross-sectional view in an optical axis direction of a part of a lens system of the lens unit 200. The mobile frame 40 has a cam pin 44 at a surface. The mobile frame 40 may have the cam pin 44 at an outer peripheral surface. The lens unit 200 includes a fixed cylinder having a cam groove in the optical axis direction on the outer peripheral surface of the mobile frame 40, and a cam ring rotatably supported by the fixed cylinder at the outer surface of the fixed cylinder and having a cam groove corresponding to the movement amount of the lens 210. When the cam ring rotates relatively to the fixed cylinder, the cam pin 44 is guided by the cam groove, and the mobile frame 40 moves in the optical axis direction together with the lens 210.

A first lens frame 41 is fixed at an object side of the mobile frame 40 by a screw, which holds a first lens group 1 including a plurality of lenses. A lens hood 43 is arranged at the outer side of the first lens frame 41 and is fixed to the mobile frame 40 by, e.g., a screw. The light amount control mechanism 35 and a second lens frame 42 are fixed at an image side of the mobile frame 40 by a screw. The second lens frame 42 holds a second lens group 2 including a plurality of lenses. The light amount control mechanism 35 is interposed between the mobile frame 40 and the second lens frame 42.

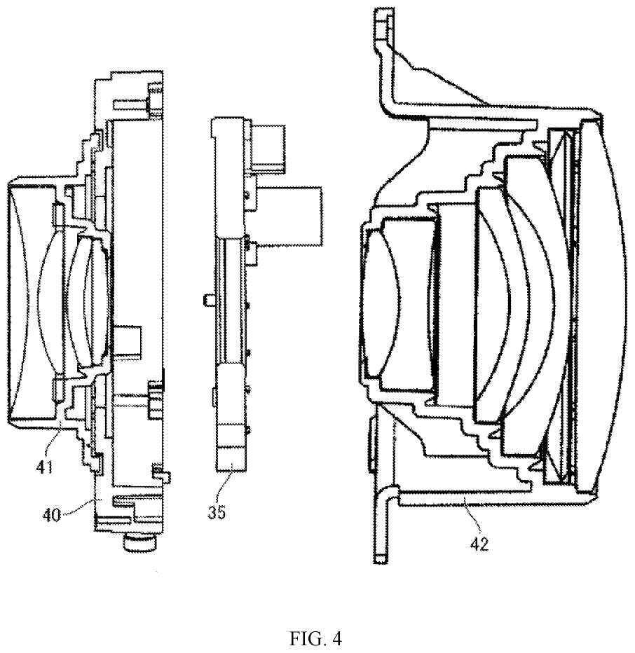

FIG. 4 is a schematic diagram showing an example of a process for removing the second lens frame 42 and the light amount control mechanism 35. As shown in FIG. 4, when the light amount control mechanism 35 is to be removed, the second lens frame 42 is considered to be first detached from the mobile frame 40, and then the light amount control mechanism 35 is removed from the mobile frame 40. However, when such a process is performed and the light amount control mechanism 35 and the second lens frame 42 are mounted at the mobile frame 40, an adjustment operation, such as centering, needs to be performed again to cause a positional relationship between the first lens group 1 and the second lens group 2 to achieve desired optical characteristics. The adjustment operation is not easy.

Therefore, in an example embodiment, the light amount control mechanism 350 can be removed while the positional relationship between the first lens group and the second lens group is maintained.

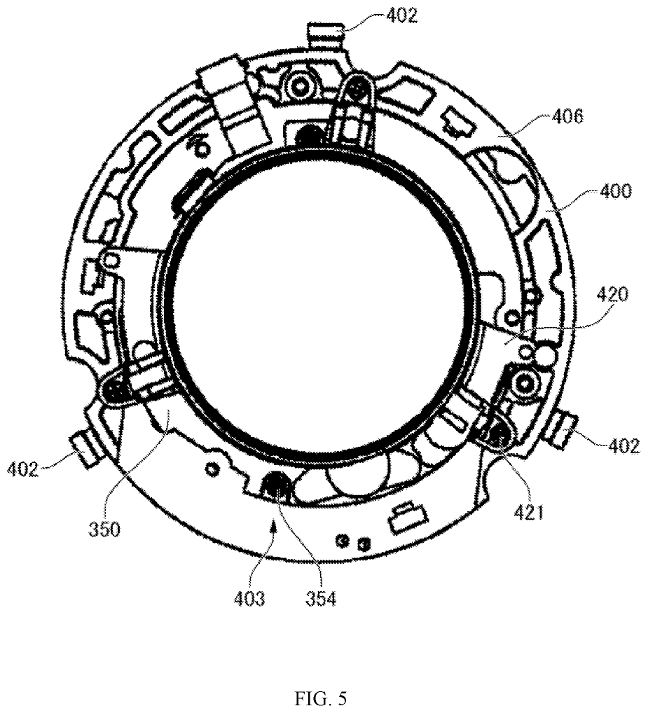

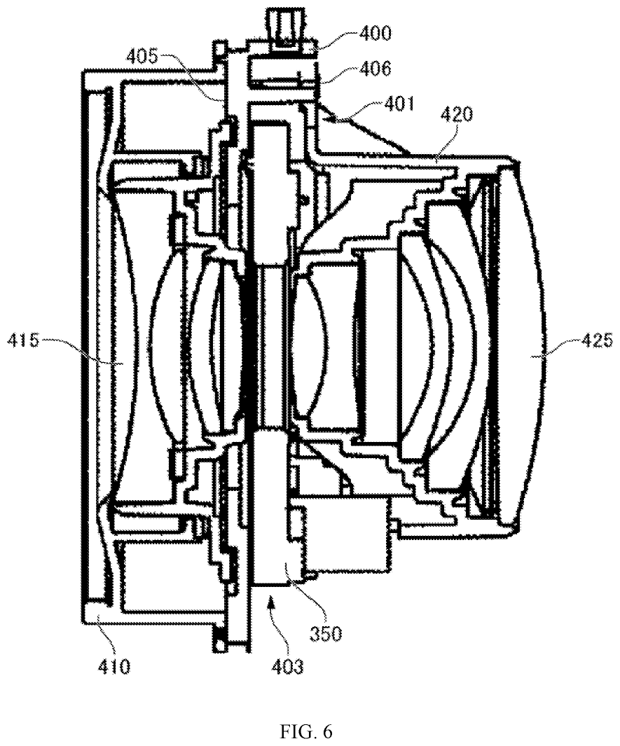

FIG. 5 is a schematic diagram showing an image-side view of the mobile frame 400, the light amount control mechanism 350, and the second lens frame 420. FIG. 6 is an example of a cross-sectional view in the optical axis direction of the first lens frame 410, the mobile frame 400, the light amount control mechanism 350, and the second lens frame 420. As shown in FIGS. 5 and 6, the light amount control mechanism 350 is arranged between the first lens group 415 held by the first lens frame 410 and the second lens group 425 held by the second lens frame 420, and is used to control the light amount through the second lens group 425. In a state where the positional relationship of the mobile frame 400 with respect to the first lens group 415 and the second lens group 425 is maintained, the light amount control mechanism 350 is detachably held. The mobile frame 400 is included as an example of a holding frame that holds the first lens group 415 and the second lens group 425. The first lens group 415 and the second lens group 425 are included as an example of the lens 210.

The mobile frame 400 is provided with recesses 401 of the light amount control mechanism 350 at a first surface 405 to which the first lens frame 410 is fixed, a second surface 406 opposite to the first surface 405 and to which the second lens frame 420 is fixed, and the second surface 406. The mobile frame 400 has a plurality of cam pins 402 protruding from the outer peripheral surface. The plurality of cam pins 402 may be radially arranged at the outer peripheral surface of the mobile frame 400. The first lens frame 410 can be finely adjusted in the optical axis direction and a direction perpendicular to the optical axis relative to the movable frame 400. The first lens frame 410 is screwed at the mobile frame 400. The lens unit 200 includes the fixed cylinder having the cam groove in the optical axis direction on the outer peripheral surface of the mobile frame 40, and the cam ring rotatably supported by the fixed cylinder at the outer surface of the fixed cylinder and having the cam groove corresponding to the movement amount of the first lens group 415 and the second lens group 425. When the cam ring rotates around the optical axis, the cam pin 402 is guided by the cam groove of the cam ring, and the mobile frame 40 moves in the optical axis direction together with the first lens group 415 and the second lens group 425.

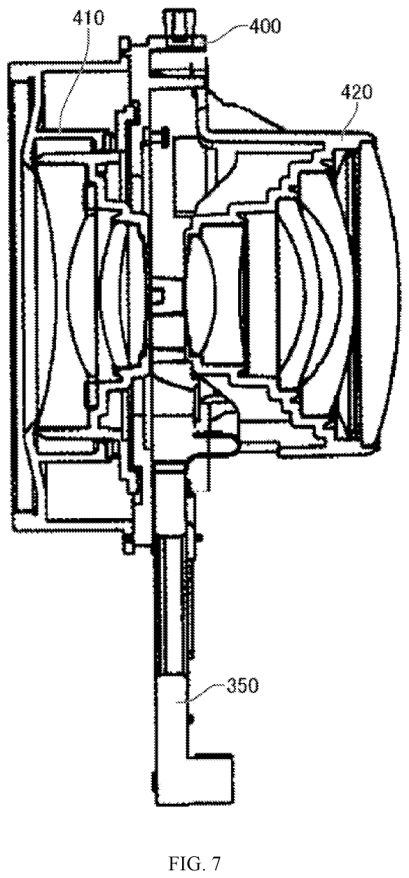

A side wall of the recess 401 has an opening 403 through which the light amount control mechanism 350 can be moved in a direction along the second surface 406 and can be removed. The opening 403 may be formed by removing a part of the side wall of the recess 401. A depth from the second surface 406 to which the second lens frame 420 is fixed to a bottom surface of the recess 401 may be greater than a thickness of the light amount control mechanism 350 in the optical axis direction. By having the opening 403 at the recess 401, the light amount control mechanism 350 can be moved relatively to the mobile frame 400 in the direction along the second surface 406 while the positional relationship between the first lens group and the second lens group is maintained, and can be removed from the mobile frame 400. That is, as shown in FIG. 7, in the state where the first lens frame 410 and the second lens frame 420 are fixed to the mobile frame 400, the light amount control mechanism 350 can be detached from the mobile frame 400 through the opening 403. When the light amount control mechanism 350 is detached from the mobile frame 400, because the positional relationship between the first lens group 415 and the second lens group 425 is maintained, when the light amount control mechanism 350 is mounted at the mobile frame 400, the adjustment operation, such as centering, does not need to be performed again to cause the positional relationship between the first lens group 415 and the second lens group 425 to achieve the desired optical characteristics. Thereby, the replacement work of the light amount control mechanism 350 becomes easy.

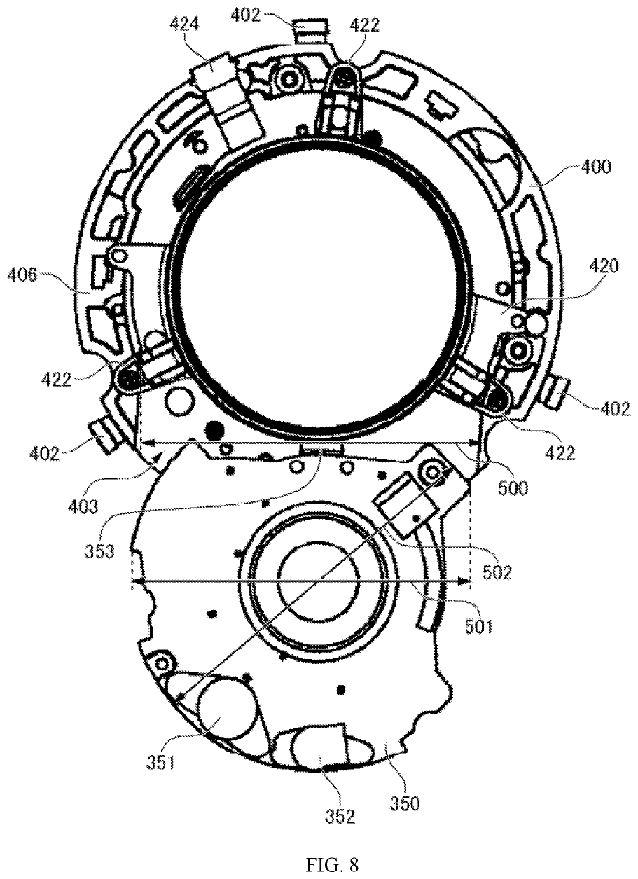

FIGS. 7 and 8 are diagrams showing an example of the state in which the light amount mobile mechanism 350 is detached from the mobile frame 400. As shown in FIG. 8, a width 500 of the opening 403 in the direction along the second surface 406 may be greater than a width 501 of the light amount control mechanism 350 in a narrowest first direction. In addition, the width 500 may be smaller than a width 502 of the light amount control mechanism 350 in a widest second direction.

The light amount control mechanism 350 is inserted into the opening 403 from a portion of the width 501 and is housed in the recess 401. After the light amount control mechanism 350 is housed in the recess 401, the light amount control mechanism 350 is rotated to a desired position in the recess 401. Accordingly, the width of the portion of the light amount control mechanism 350 facing the opening 403 is larger than the width of the opening 403, and the light amount control mechanism 350 is difficult to escape from the recess 401.

The light amount control mechanism 350 may include a motor 351 and a motor 352 which are power sources of the aperture mechanism and the shutter mechanism included in the light amount control mechanism 350, at a peripheral edge opposite to the peripheral edge at an insertion side of the opening 403.

The mobile frame 400 includes a connection terminal 424 for electrical connection with the light amount control mechanism 350. The light amount control mechanism 350 includes a connection terminal 353 for electrical connection with the mobile frame 400. After the light amount control mechanism 350 is housed in the recess 401, the connection terminal 424 and the connection terminal 353 are electrically connected via a flexible cable.

The second lens frame 420 includes a fixation member 422 for fixing the second lens frame 420 to the mobile frame 400. A plurality of fixation members 422 may be arranged radially from the outer peripheral surface of the second lens frame 420. The second lens frame 420 is screwed to the mobile frame 400 through the fixation member 422. The second lens frame 420 and the light amount control mechanism 350 are fixed at the mobile frame 400 by another screw. The second lens frame 420 is fixed to the mobile frame 400 by a screw 421 penetrating the fixation member 422. The light amount control mechanism 350 is fixed in the recess 401 of the mobile frame 400 by a screw 354. When the second lens frame 420 is fixed at the mobile frame 400, the screw 354 is not covered by the second lens frame 420 and can be removed from the mobile frame 400.

In the state where the second lens frame 420 is fixed to the mobile frame 400, the fixation member 422 is located outside the outer peripheral surface of the light amount control mechanism 350 at the second surface 406. The fixation member 422 is fixed at a position adjacent to the outer edge of the mobile frame 400 to cause the fixation member 422 to be positioned as far away from the optical axis as possible. Thereby, the accuracy of the second lens group 425 with respect to a pitch direction of the mobile frame 400 may be maximized.

According to the lens unit 200 of the embodiments, while the positional relationship between the first lens group 415 and the second lens group 425 is maintained, the light amount control mechanism 350 can be assembled and disassembled relative to the mobile frame 400 through the opening 403 provided on the mobile frame 400. Therefore, when the light amount control mechanism 350 is mounted at the mobile frame 400, the adjustment operation, such as centering, does not need to be performed again to cause the positional relationship between the first lens group 415 and the second lens group 425 to achieve the desired optical characteristics. Thereby, the replacement work of the light amount control mechanism 350 becomes easy.

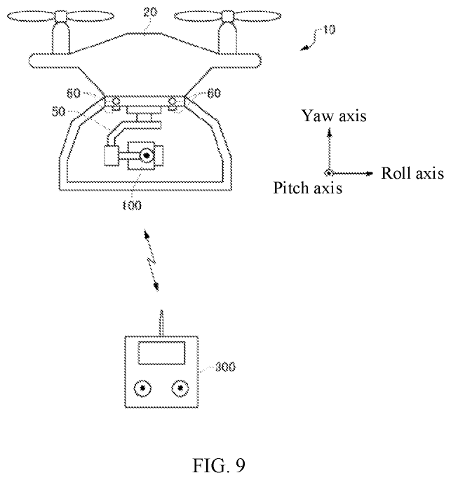

The imaging device 100 as described above may be mounted at a mobile object. The imaging device 100 may also be mounted at an unmanned aerial vehicle (UAV) shown in FIG. 9. FIG. 9 is a diagram showing an example appearance of an unmanned aerial vehicle (UAV) 10 and a remote control 300. The UAV 10 includes a UAV main body 20, a gimbal 50, a plurality of imaging devices 60, and an imaging device 100. The gimbal 50 and the imaging device 100 are included as an example imaging system. The UAV 10 is included as an example mobile object propelled by a propulsion system. The mobile object may include a flight object movable in the air, a vehicle movable on the ground, or a ship movable on the water, etc. The flight object movable in the air may include an aircraft such as a UAV, an airship, or a helicopter, etc.

The UAV main body 20 includes a plurality of rotors. The plurality of rotors are included as an example propulsion system. The UAV main body 20 enables the UAV 10 to fly by controlling the rotation of the plurality of rotors. The UAV main body 20 uses, for example, four rotors to enable the UAV 10 to fly. The number of rotors is not limited to four. In addition, the UAV 10 may also be a fixed-wing aircraft without rotors.

The imaging device 100 includes an imaging camera used to shoot an object included in a desired shooting range. The gimbal 50 may rotatably support the imaging device 100. The gimbal 50 is included as an example supporting mechanism. For example, the gimbal 50 supports the imaging device 100 so that it may be rotated around a pitch axis using an actuator. The gimbal 50 supports the imaging device 100 to enable the imaging device 100 to rotate around a roll axis or a yaw axis using an actuator. The gimbal 50 may change the attitude of the imaging device 100 by rotating the imaging device 100 around at least one of the yaw axis, the pitch axis, or the roll axis.

The plurality of imaging devices 60 include sensing cameras used to shoot surroundings of the UAV 10 to control the flight of the UAV 10. Two of the imaging devices 60 may be mounted at the nose, i.e., at a front, of the UAV 10. In addition, another two of the imaging devices 60 may be mounted at a bottom of the UAV 10. The two imaging devices 60 at the front of the UAV 10 may be paired to function as a stereo camera. The two imaging devices 60 at the bottom of the UAV 10 may also be paired to function as a stereo camera. Three-dimensional spatial data around the UAV 10 may be generated according to images taken by the plurality of imaging devices 60. The number of the imaging devices 60 included in the UAV 10 is not limited to four. The UAV 10 includes at least one imaging device 60. The UAV 10 may include at least one imaging device 60 at each of the nose, tail, side, bottom, and top of the UAV 10. A settable viewing angle of the imaging device 60 may be larger than the settable viewing angle of the imaging apparatus 100. The imaging device 60 may have a single focus lens or a fisheye lens.

The remote control 300 communicates with the UAV 10 to operate the UAV 10 remotely. The remote control 300 may communicate with the UAV 10 wirelessly. The remote control 300 sends the UAV 10 instruction information indicating various instructions related to the movement of the UAV 10 such as ascending, descending, accelerating, decelerating, forwarding, retreating, and/or rotating. The instruction information includes, for example, the instruction information for raising a flight altitude of the UAV 10. The instruction information may indicate a desired flight altitude of the UAV 10. The UAV 10 may move to the desired flight altitude indicated by the instruction information received from the remote control 300. The instruction information may include an ascending instruction to instruct the UAV 10 to ascend. The UAV 10 may ascend after receiving the ascending instruction. When the flight altitude of the UAV 10 has reached a maximum flight altitude, even if the ascending instruction is received, the UAV 10 may be restricted from ascending.

An execution order of the actions, sequences, processes, and stages in the devices, systems, programs, and methods consistent with claims, specification, and drawings, as long as there is no special indication “before,” “in advance,” etc., and as long as an output of previous processing is not used in the subsequent processing, may be implemented in any order. Regarding the operating procedures in the claims, the specification, and the drawings, terms “first,” “next,” etc. used in the descriptions for convenience, but do not limit an implementation order.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A lens device comprising:
a first lens group including at least a lens;
a second lens group including at least another lens;
a light amount control mechanism arranged between the first lens group and the second lens group, and configured to control a light amount through the second lens group; and
a holding frame configured to detachably hold the light amount control mechanism in a state that a positional relationship between the first lens group and the second lens group is maintained.

2. The lens device of claim 1, further comprising:
a first lens frame configured to hold the first lens group; and
a second lens frame configured to hold the second lens group;
wherein the first lens frame and the second lens frame are fixed at the holding frame.

3. The lens device of claim 2, wherein:
the holding frame includes:
a first surface to which the first lens frame is fixed;
a second surface to which the second lens frame is fixed;
a recess provided at the second surface and configured to mount the light amount control mechanism; and
an opening is provided at a side wall of the recess and configured to allow the light amount control mechanism to move and be mounted and removed along a direction of the second surface.

4. The lens device of claim 3, wherein:
the second lens frame includes a fixation member configured to fix the second lens frame to the holding frame; and
the fixation member is located outside an outer peripheral surface of the light amount control mechanism at the second surface in a state that the second lens frame is fixed at the holding frame.

5. The lens device of claim 3, wherein a width of the opening along the direction of the second surface is greater than a width of the light amount control mechanism along a first direction of a surface opposite to the second lens group, and is smaller than a width of the light amount control mechanism along a second direction of the surface opposite to the second lens group.

6. The lens device of claim 2, wherein:
the second lens frame is fixed at the holding frame through a first screw; and
the light amount control mechanism is fixed at the holding frame through a second screw.

7. The lens device of claim 2, wherein:
the holding frame includes:
a first surface to which the first lens frame is fixed;
a second surface to which the second lens frame is fixed; and
a recess provided at the second surface and configured to mount the light amount control mechanism;
the second lens frame includes a fixation member configured to fix the second lens frame to the holding frame; and
the fixation member is located outside an outer peripheral surface of the light amount control mechanism at the second surface in a state that the second lens frame is fixed at the holding frame.

8. The lens device of claim 7, wherein:
the second lens frame is fixed at the holding frame through a first screw penetrating the fixation member; and
the light amount control mechanism is fixed in the recess of the holding frame through a second screw.

9. The lens device of claim 1, further comprising:
a cam ring configured to movably support the holding frame in an optical axis direction through a cam groove.

10. The lens device of claim 9, wherein the holding frame is configured to move in the optical axis direction through the cam groove with a rotation of the cam ring to enable the first lens group and the second lens group to move along the optical axis direction.

11. The lens device of claim 1, wherein the light amount control mechanism includes at least one of an aperture mechanism or a shutter mechanism.

12. An imaging device comprising:
an image sensor; and
a lens device including:
a first lens group including at least a lens;
a second lens group including at least another lens;
a light amount control mechanism arranged between the first lens group and the second lens group, and configured to control a light amount through the second lens group; and
a holding frame configured to detachably hold the light amount control mechanism in a state that a positional relationship between the first lens group and the second lens group is maintained.

13. The imaging device of claim 12, wherein the lens device further includes:
a first lens frame configured to hold the first lens group; and
a second lens frame configured to hold the second lens group;
wherein the first lens frame and the second lens frame are fixed at the holding frame.

14. The imaging device of claim 13, wherein:
the holding frame includes:
a first surface to which the first lens frame is fixed;
a second surface to which the second lens frame is fixed;
a recess provided at the second surface and configured to mount the light amount control mechanism; and
an opening is provided at a side wall of the recess and configured to allow the light amount control mechanism to move, and be mounted and removed along a direction of the second surface.

15. The imaging device of claim 14, wherein:
the second lens frame includes a fixation member configured to fix the second lens frame to the holding frame; and
the fixation member is located outside an outer peripheral surface of the light amount control mechanism at the second surface in a state that the second lens frame is fixed at the holding frame.

16. The imaging device of claim 14, wherein a width of the opening along the direction of the second surface is greater than a width of the light amount control mechanism along a first direction of a surface opposite to the second lens group, and is smaller than a width of the light amount control mechanism along a second direction of the surface opposite to the second lens group.

17. The imaging device of claim 13, wherein:
the second lens frame is fixed at the holding frame through a first screw; and
the light amount control mechanism is fixed at the holding frame through a second screw.

18. The imaging device of claim 13, wherein:
the holding frame includes:
a first surface to which the first lens frame is fixed;
a second surface to which the second lens frame is fixed; and
a recess provided at the second surface and configured to mount the light amount control mechanism;
the second lens frame includes a fixation member configured to fix the second lens frame to the holding frame; and
the fixation member is located outside an outer peripheral surface of the light amount control mechanism at the second surface in a state that the second lens frame is fixed at the holding frame.

19. The imaging device of claim 18, wherein:
the second lens frame is fixed to the holding frame through a first screw penetrating the fixation member; and
the light amount control mechanism is fixed in the recess of the holding frame through a second screw.

20. A mobile object configured to move, comprising:
an imaging device including:
an image sensor; and
a lens device including:
a first lens group including at least a lens;
a second lens group including at least another lens;
a light amount control mechanism arranged between the first lens group and the second lens group, and configured to control a light amount through the second lens group; and
a holding frame configured to detachably hold the light amount control mechanism in a state that a positional relationship between the first lens group and the second lens group is maintained.
